(19) United States
(12) Patent Application Publication
(10) Pub. No.: US 2018/0274520 A1
(43) Pub. Date: Sep. 27, 2018

(54) METHOD FOR EVALUATING POWER CHARACTERISTICS OF WIND TURBINES, APPARATUS AND STORAGE MEDIUM

(71) Applicants: CHINA ELECTRIC POWER RESEARCH INSTITUTE COMPANY LIMITED, Beijing (CN); STATE GRID CORPORATION OF CHINA, Beijing (CN); CLP PURI ZHANGBEI WIND POWER RESEARCH & TESTING CO., LTD., Zhangjiakou (CN)

(72) Inventors: Weisheng Wang, Beijing (CN); Yang Xue, Beijing (CN); Ruiming Wang, Beijing (CN); Xiaojing Ma, Beijing (CN); Deyi Fu, Beijing (CN); Wei Bian, Beijing (CN); Songdi Li, Beijing (CN); Chen Chen, Beijing (CN); Yong Sun, Beijing (CN)

(21) Appl. No.: 15/958,246

(22) Filed: Apr. 20, 2018

Related U.S. Application Data
(63) Continuation of application No. PCT/CN2016/088016, filed on Jun. 30, 2016.

(30) Foreign Application Priority Data
Dec. 2, 2015 (CN) 201510870017.7

(51) Int. Cl. F03D 17/00; G01P 5/26; G01P 5/06

(52) U.S. Cl. CPC F03D 17/00; G01P 5/26; G01P 5/06; F05B 2270/8042; F05B 2260/80; F05B 2220/706; F05B 2270/32

(57) ABSTRACT

A method for evaluating power characteristics of wind turbines, an apparatus and a storage medium. By means of verifying master control operating data of the wind turbines (1), correcting nacelle wind speed data (2), and calculating a power curve of the wind turbines and a guarantee value for the power curve, a wind turbine power characteristics evaluation result (3) is obtained. The present method economically and efficiently evaluates a power characteristics curve for wind turbines, makes full use of existing operating data of the wind turbine master control system, and performs evaluation of the power characteristics of wind turbines of a same model in a wind farm. The method ensures accuracy and test efficiency, and controls test times within one month, thereby ensuring the reliability and high efficiency of the wind turbines.

### CROSS-REFERENCE TO RELATED APPLICATION

This is a continuation application of PCT Application No. PCT/CN2016/088016 filed on Jun. 30, 2016 claiming priority to Chinese Patent Application No. 201510870017.7 filed on Dec. 2, 2015, the disclosure of these applications are incorporated by reference herein in their entireties.

### TECHNICAL FIELD

The disclosure relates to the field of new energy power generation, and particularly to evaluation method device and a storage medium for evaluating power performance of a wind turbine generator.

### BACKGROUND

Wind turbine generator power performance is one of important performance indexes directly related to energy production, of a wind turbine generator, and it reflects a relationship between a free stream wind velocity and net power output of the wind turbine generator. Poor power performance of the wind turbine generator means low energy production of a wind turbine generator for the same capacity, and means that an investor may not get an equivalent return. Therefore, power performance attracts great attention of a wind turbine generator manufacturer and a wind power plant developer.

Power performance measurement of the wind turbine generator is a most direct method for obtaining such a performance index of a wind turbine generator. A method for carrying out performance measurement of the wind turbine generator power is specified by standards such as GB/T 18451.2-2012 “Power Performance Measurement of Wind turbine generator” and IEC 61400-12-2:2013 “Nacelle Anemometer Based Power Performance Measurement of Wind turbine generator”. However, power performance measurement according to the standard requires a time of at least about 3 months. There are more than 20 wind turbine generator manufacturers in China, new models emerge one after another, and a large number of wind turbine generators require quality acceptance. Therefore, there is a great demand in power performance evaluation of the wind turbine generator as well as an urgent need for a convenient and economical method for preliminarily evaluating power performance of the wind turbine generator.

### SUMMARY

In order to solve the technical problem, embodiments of the disclosure provide a power performance evaluation method and device for evaluating wind turbine generator and a storage medium. By the method, a power performance curve of the wind turbine generator is economically and efficiently evaluated, and power performance evaluation of all wind turbine generators of the same model in a wind power plant is implemented by fully utilizing operation data of an existing master control system of the wind turbine generator. Both accuracy and measurement efficiency is ensured, and a measurement time is within a month. Furthermore, reliable operation and efficient utilization rate of the wind turbine generator are ensured.

A evaluation method for evaluating power performance of a wind turbine generator provided by the embodiments of the disclosure is adopted to evaluate power performance of a wind turbine generator in a wind power plant, the wind turbine generator being connected with a master control system of the wind turbine generator master control system and a wind turbine generator controller to evaluate power performance of the wind turbine generator, the method including the following steps:

verifying master control operation data of the wind generator;

correcting a nacelle wind velocity data; and

calculating a wind turbine generator power curve and a power curve guarantee value, and obtaining a power performance evaluation result of the wind turbine generator.

In the embodiments of the disclosure, the verification of the master control operation data of the wind turbine generator includes:

outputting, by the wind turbine generator master control system, the master control operation data used as theoretical data, the master control operation data comprising a nacelle wind velocity and an output power signal;

verifying whether the master control operation data is the same as practical measurement data;

if the master control operation data is the same as practical measurement data, correcting the nacelle wind velocity data; and

if the master control operation data is not the same as practical measurement data, checking input and output of a signal of the wind turbine generator controller, and controlling the master control system to correct the signal of the wind turbine generator controller.

In the embodiments of the disclosure, the correction of the nacelle wind velocity data includes:

determining whether an authenticated nacelle transfer function (NTF) has currently been acquired;

if the authenticated nacelle transfer function has been acquired, correcting the nacelle wind velocity data directly by virtue of the authenticated nacelle transfer function;

if the authenticated nacelle transfer function has not been acquired, selecting a typical wind turbine generator in the wind power plant;

arranging an anemometer tower within a range of twofold to fourfold wind turbine diameter of the typical wind turbine generator, and measuring wind velocity and wind direction signals on the anemometer tower;

calculating a mean of measured wind velocity and wind direction signal data within 2 min, the nacelle wind velocity being an independent variable and a measured wind velocity being a dependent variable, dividing a wind velocity range into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, data in the intervals comprising wind velocities which are comprised between 1 m/s lower than a cut-in wind velocity and 1.5 times of a wind velocity corresponding to rated power 85% of the wind turbine generator, and when there are at least three data in each interval, obtaining an nacelle transfer function represented by an interval-based mathematical function by fitting, the nacelle transfer function being a function in which nacelle wind velocities in each interval are used as measured wind velocities; and calculating the free stream wind velocity.

In the embodiments of the disclosure, the measurement of the wind velocity and wind direction signals on the anemometer tower includes:

mounting a cup anemometer and a wind vane on the anemometer tower, and measuring, by the cup anemometer and the wind vane, the wind velocity and wind direction signals;

or mounting a Lidar on the anemometer tower, and measuring, by the Lidar, the wind velocity and wind direction signals.

In the embodiments of the disclosure, the calculation of the free stream wind velocity includes:

calculating the free stream wind velocity V_{free} which is estimated by adopting the measured nacelle wind velocity and a wind velocity of the anemometer tower and corrected in consideration of an air flow distortion caused by a terrain according to the NTF:

$${V}_{free} = \frac{{V}_{m , i + 1} - {V}_{m , i}}{{V}_{nacelle , i + 1} - {V}_{nacelle , i}} \times ( {V}_{nacelle} - {V}_{nacelle , i} ) + {V}_{m , i} ,$$

where V_{nacelle} is the nacelle wind velocity in each interval, Vₘ is the measured wind velocity, V_{nacelle,i} and V_{nacelle,i+1} are interval means of the nacelle wind velocities in an interval i and an interval i+1 respectively, and are obtained through the NTF, V_{m,i} and V_{m,i+1} are interval means of wind velocities of the anemometer tower in the interval i and the interval i+1 respectively, and are obtained through the NTF, and V_{nacelle} is a measured value of the nacelle anemometer, and is configured to estimate the free stream wind velocity.

In the embodiments of the disclosure, the calculation of the wind turbine generator power curve and the power curve guarantee value and the obtainment of the power performance evaluation result of the wind turbine generator includes:

calculating a measurement power curve and power curve guarantee value of the evaluated wind turbine generator according to the corrected nacelle wind velocity and output power of the wind turbine generator; and

determining whether the power curve guarantee value of the evaluated wind turbine generator reaches a value guaranteed by a manufacturer and obtaining the power performance evaluation result of the wind turbine generator.

In the embodiments of the disclosure, the calculation of the measurement power curve and power curve guarantee value of the evaluated wind turbine generator according to the corrected nacelle wind velocity and output power of the wind turbine generator includes:

standardizing all measured data to a sea-level air density, and standardizing output power of a fixed-pitch and fixed-velocity stall regulation wind turbine generator according to an International Standardization Organization (ISO) standard atmospheric density:

$${P}_{n} = {P}_{10 min} \cdot \frac{{ρ}_{0}}{{ρ}_{10 min}} ,$$

where Pₙ is the standardized output power, P_{10 min} is a measured power mean of 10 min, ρ₀ is a standard air density, and ρ_{10 min} is an air density mean of 10 min,

where ρ_{10 min} is:

$${ρ}_{10 min} = \frac{{B}_{10 min}}{{R}_{0} \cdot {T}_{10 min}} ,$$

where T_{10 min} is an absolute air temperature mean of 10 min, B_{10 min} is an air pressure mean of 10 min, and R₀ is a gas constant 287.05 J/(kg×K) of dry air;

standardizing a wind velocity of an active power controlled wind turbine generator:

$${V}_{n} = {{V}_{10 min} ( \frac{{ρ}_{10 min}}{{ρ}_{0}} )}^{1 \text{/} 3} ,$$

where Vₙ is the standardized wind velocity, and V_{10 min} is a measured wind velocity mean of 10 min;

calculating a standardized mean wind velocity Vᵢ and mean output power Pᵢ of the interval i to be:

$${V}_{i} = \frac{1}{{N}_{i}} {Σ}_{j = 1}^{{N}_{i}} {V}_{n , i , j}$$

$${P}_{i} = \frac{1}{{N}_{i}} {Σ}_{j = 1}^{{N}_{i}} {P}_{n , i , j} ,$$

where V_{n,i,j} is a standardized wind velocity of an array j of the interval i, P_{n,i,j} is standardized mean output power of the array j of the interval i, and Nᵢ is the number of arrays in the interval i of 10 min;

obtaining measured Annual Energy Production (AEP) by the measurement power curve, obtaining guaranteed energy production by a power curve guaranteed by a contract, and estimating the annual energy production, AEP, according to the following formula:

$$AEP = {N}_{h} {\sum }_{i = 1}^{N} [ F ( {V}_{i} ) - F ( {V}_{i - 1} ) ] ( \frac{{P}_{i - 1} + {P}_{i}}{2} ) ,$$

where Nₕ is the number of hours in a year, and is about 8,760 hours, N is the number of the intervals, and F(V) is a Rayleigh cumulative probability distribution function of the wind velocity,

where F(V) is

$$F ( V ) = 1 - exp ( - \frac{π}{4} {( \frac{V}{{V}_{ave}} )}^{2} ) ,$$

where Vₐᵥₑ is an annual mean wind velocity at a hub height, and V is the wind velocity;

performing summation initialization setting:

set Vᵢ₋₁ to be equal to Vᵢ−0.5 m/s, and setting Pᵢ₋₁ to be equal to 0.0 kW; and

adopting wind resource data at hub height, which is provided in a project engineering bidding document of the wind power plant, as the annual mean wind velocity of the hub height, and obtaining the power curve guarantee value k:

k=(AEP-measured value/AEP-guarantee value)×100%.

From the abovementioned technical solutions, it can be seen that the embodiments of the disclosure provide the evaluation method for evaluating power performance of a wind turbine generator and device and the storage medium. The master control operation data of the wind turbine generator is verified; the nacelle wind velocity data is corrected; and the wind turbine generator power curve and the power curve guarantee value are calculated, and the wind turbine generator power performance evaluation result is obtained. By the method disclosed by the disclosure, a power performance curve of the wind turbine generator is economically and efficiently evaluated, and power performance evaluation of all wind turbine generators of the same model in the wind power plant is implemented by fully utilizing operation data of an existing master control system of the wind turbine generator. Not only accuracy is ensured, but also measurement efficiency is ensured, and a measurement time is controlled within a month. Furthermore, reliable operation and efficient utilization rates of the wind turbine generators are ensured.

The technical solutions of the embodiments of the disclosure at least have the following good effects.

1: in the technical solutions provided by the disclosure, the wind turbine generator power performance curve may be economically and efficiently evaluated, and only one representative wind turbine generator in the wind power plant is required to be measured to implement power performance evaluation of all the wind turbine generators of the same model in the wind power plant by fully utilizing the operation data of the existing master control system of the wind turbine generator.

2: according to the technical solutions provided by the disclosure, mean data of 2 min is adopted when determining the NTF of the wind turbine generator, so that the obtained NTF not only ensures the accuracy, but also ensures the measurement efficiency, and controls the measurement time within a month.

3: according to the technical solutions provided by the disclosure, the Lidar may be adopted to measure the NTF, and there is no need to arrange an anemometer tower of the hub height, so that evaluation cost is reduced.

4: according to the technical solutions provided by the disclosure, reliable operation and efficient utilization rate of the wind turbine generator are ensured.

5: the technical solutions provided by the disclosure can be widely applied, and have remarkable social benefits and economic benefits.

### BRIEF DESCRIPTION OF DRAWINGS

FIG. 1 is a flowchart of evaluation method for evaluating power performance of a wind turbine generator according to an embodiment of the disclosure.

FIG. 2 is a flowchart of Step 1 in an evaluation method according to an embodiment of the disclosure.

FIG. 3 is a flowchart of Step 2 in an evaluation method according to an embodiment of the disclosure.

FIG. 4 is a flowchart of Step 3 in an evaluation method according to an embodiment of the disclosure.

FIG. 5 is a structure diagram of an evaluation device for evaluating power performance of a wind turbine generator according to an embodiment of the disclosure.

### DETAILED DESCRIPTION

The technical solutions in the embodiments of the disclosure will be clearly and completely described below in combination with the drawings in the embodiments of the disclosure. It should be noted that the described embodiments are not all embodiments but part of embodiments of the disclosure. All other embodiments obtained by those skilled in the art on the basis of the embodiments in the disclosure without creative work shall fall within the scope of protection of the disclosure.

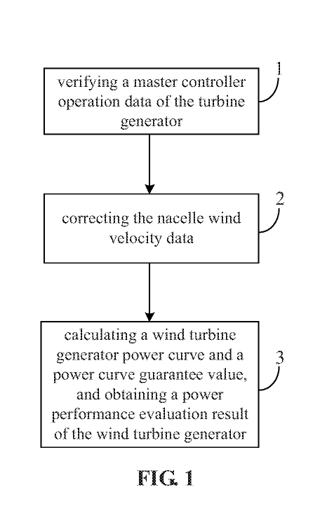

As shown in FIG. 1, an embodiment of the disclosure provides an evaluation method for evaluating power performance of a wind turbine generator, which includes the following steps.

In Step 1, master control operation data of the wind turbine generator is verified.

In Step 2, nacelle wind velocity data is corrected.

In Step 3, a power curve of the wind turbine generator and a power curve guarantee value are calculated, and a power performance evaluation result of the wind turbine generator is obtained.

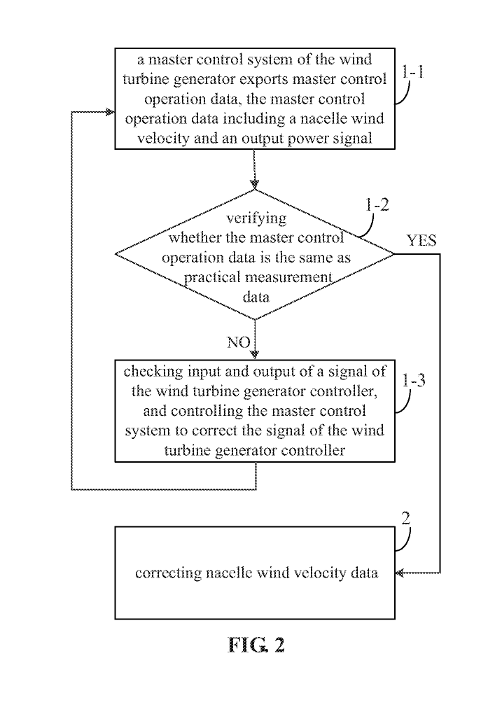

As shown in FIG. 2, Step 1 includes the following steps.

In 1-1, a wind turbine generator master control system exports master control operation data including the nacelle wind velocity and an output power signal.

In 1-2, it is verified whether the master control operation data is the same as practical measurement data;

if the master control operation data is the same as practical measurement data, go to Step 2; and

if the master control operation data is not the same as practical measurement data, go to 1-3.

In 1-3, input and output of a wind turbine generator controller signal are checked, and the master control system is controlled to correct the wind turbine generator controller signal; then 1-1 is re-executed.

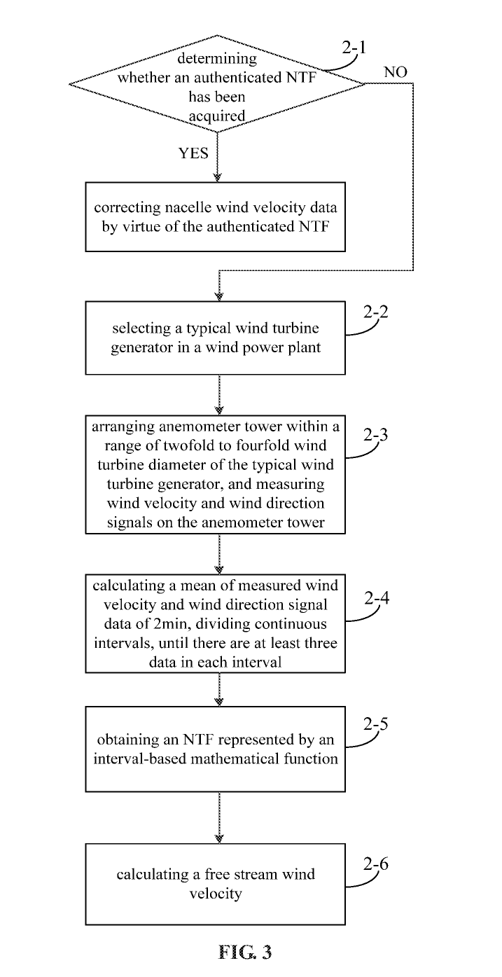

As shown in FIG. 3, Step 2 includes the following steps.

In 2-1, it is determined whether an authenticated NTF has been acquired; if the authenticated NTF has been acquired, the nacelle wind velocity data is corrected directly by using the authenticated NTF; and if the authenticated NTF has not been acquired, go to 2-2.

In 2-2, a typical wind turbine generator in a wind power plant is selected, the typical wind turbine generator is a wind turbine generator which is representative in terms of terrain and wind resource in the wind power plant.

In 2-3, an anemometer tower is arranged within range of twofold to fourfold wind turbine diameter of the typical wind turbine generator, and wind velocity and wind direction signals are measured on the anemometer tower.

In 2-4, a mean of measured wind velocity and wind direction signal data within 2 min is calculated, the nacelle wind velocity being an independent variable and a measured wind velocity being a dependent variable, a wind velocity range is divided into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, data in the intervals including wind velocities which are comprised between 1 m/s lower than a cut-in wind velocity and 1.5 times of a wind velocity corresponding to rated power 85% of the wind turbine generator, and when there are at least three data fall into each interval, go to 2-5.

In 2-5, an NTF represented by an interval-based mathematical function is obtained by fitting, the NTF being a function in which nacelle wind velocities in each interval are used as measured wind velocities.

In 2-6, the free stream wind velocity is calculated.

The measurement of wind velocity and wind direction signals on the anemometer tower in 2-3 includes that:

a cup anemometer and a wind vane are mounted on the anemometer tower, and the cup anemometer and the wind vane measure the wind velocity and wind direction signals;

or a Lidar is mounted on the anemometer tower, and the Lidar measures the wind velocity and wind direction signals.

2-6 includes that:

a free stream wind velocity V_{free} is calculated according to the NTF, the free stream wind velocity is estimated by the measured nacelle wind velocity and a wind velocity of the anemometer tower and is corrected considering an air flow distortion caused by a terrain:

$${V}_{free} = \frac{{V}_{m , i + 1} - {V}_{m , i}}{{V}_{nacelle , i + 1} - {V}_{nacelle , i}} \times ( {V}_{nacelle} - {V}_{nacelle , i} ) + {V}_{m , i} , \qquad ( 1 )$$

in the formula (1): V_{nacelle} being the nacelle wind velocity in each interval; Vₘ being the measured wind velocity; V_{nacelle,i} and V_{nacelle,i+1} being interval means of the nacelle wind velocities in an interval i and an interval i+1 respectively, and being obtained through the NTF; V_{m,i} and V_{m,i+1} being interval means of wind velocities of the anemometer tower in the interval i and the interval i+1 respectively, and being obtained through the NTF; and V_{nacelle} being a measured value of the nacelle anemometer, and being configured to estimate the free stream wind velocity.

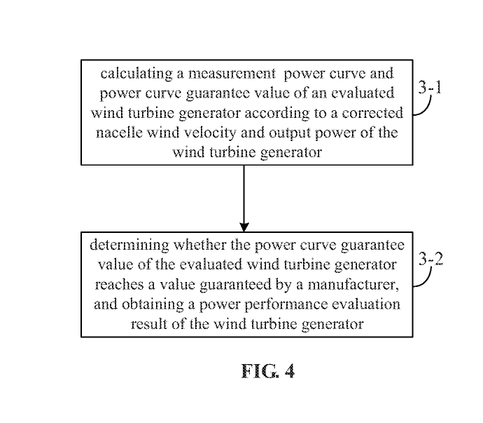

As shown in FIG. 4, Step 3 includes the following steps.

In 3-1, a measurement power curve and power curve guarantee value of the evaluated wind turbine generator are calculated according to the corrected nacelle wind velocity and output power of the wind turbine generator.

In 3-2, it is determined whether the power curve guarantee value of the evaluated wind turbine generator reaches a value guaranteed by a manufacturer, and then a power performance evaluation result of the wind turbine generator is obtained.

3-1 includes the following steps.

a) all measured data is standardized to a sea-level air density, and output power of a fixed-pitch and fixed-velocity stall regulation wind turbine generator is standardized according to an ISO standard atmospheric density:

$${P}_{n} = {P}_{10 min} \cdot \frac{{ρ}_{0}}{{ρ}_{10 min}} , \qquad ( 2 )$$

in the formula (2): Pₙ being the standardized output power, P_{10 min} being a measurement power mean of 10 min, ρ₀ being a standard air density, and ρ_{10 min} being an air density mean of 10 min,

where ρ_{10 min} is:

$${ρ}_{10 min} = \frac{{B}_{10 min}}{{R}_{0} \cdot {T}_{10 min}} , \qquad ( 3 )$$

in the formula (3): T_{10 min} being an absolute air temperature mean of 10 min, B_{10 min} being an air pressure mean of 10 min, and being a gas constant 287.05 J/(kg×K) of dry air.

b) a wind velocity of an active power controlled wind turbine generator is standardized:

$${V}_{n} = {{V}_{10 min} ( \frac{{ρ}_{10 min}}{{ρ}_{0}} )}^{1 / 3} , \qquad ( 4 )$$

in the formula (4): Vₙ being the standardized wind velocity, and V_{10 min} being a measured wind velocity mean of 10 min.

c) a standardized mean wind velocity Vᵢ and mean output power Pᵢ of the interval i are calculated as follows:

$$\begin{matrix}{V}_{i} = \frac{1}{{N}_{i}} {\sum }_{j = 1}^{{N}_{i}} {V}_{n , i , j} & ( 5 ) \\ {P}_{i} = \frac{1}{{N}_{i}} {\sum }_{j = 1}^{{N}_{i}} {P}_{n , i , j} & ( 6 )\end{matrix}$$

where V_{n,i,j} is a standardized wind velocity of an array j of the interval i, P_{n,i,j} is standardized mean output power of the array j of the interval i, and Nᵢ is a number of arrays in the interval i within 10 min.

d) measurement of AEP is obtained by the measurement power curve, guaranteed energy production is obtained by a power curve guaranteed by a contract, and the Annual Energy Production AEP is estimated according to the following formula:

$$AEP = {N}_{h} {\sum }_{i = 1}^{N} [ F ( {V}_{i} ) - F ( {V}_{i - 1} ) ] ( \frac{{P}_{i - 1} + {P}_{i}}{2} ) , \qquad ( 7 )$$

in the formula (7): Nₕ being a number of hours in a year, and being about 8,760 hours, N being a number of the intervals, and F(V) being a Rayleigh cumulative probability distribution function of the wind velocity,

where F(V) is:

$$F ( V ) = 1 - exp ( - \frac{π}{4} {( \frac{V}{{V}_{ave}} )}^{2} ) , \qquad ( 8 )$$

in the formula (8): Vₐᵥₑ being an annual mean wind velocity at a hub height, and V being the wind velocity.

e) summation initialization setting is performed:

set Vᵢ₋₁ to be equal to equal to Vᵢ−0.5 m/s, and set Pᵢ₋₁ to be equal to 0.0 kW.

f) wind resource data at hub height provided in a project engineering bidding document of the wind power plant is adopted for the annual mean wind velocity at the hub height, and the power curve guarantee value k is obtained:

k=(AEP-measured value/AEP-guarantee value)×100% (9).

A specific application example of the evaluation method for evaluating power performance of a wind turbine generator provided by the disclosure specifically includes the following three stages: master control operation data of the wind turbine generator is verified; a nacelle wind velocity is corrected; and a wind turbine generator power curve and AEP are calculated.

(I) The Verification of the Master Control Operation Data of the Wind Turbine Generator:

Since operation data exported by the master control system of the wind turbine generator is required to be used in the evaluation method of the specific application example, it is necessary to verify the nacelle wind velocity and output power signal exported by a master controller to determine that the nacelle wind velocity and output power are consistent with practical data at first. It is necessary to check input and output of a wind turbine generator controller signal and consider correction of the master control system for the signal, so as to ensure that a correct final signal value is used.

(II) The Correction of the Nacelle Wind Velocity:

If an authenticated NTF may be obtained, the nacelle wind velocity may be corrected directly by virtue of the NTF. The specific application example focuses on such a condition that no NTF can be provided. According to the method, An NTF obtained in a certain wind power plant according to the present method is only applied to wind turbine generators of the same model.

A typical wind turbine generator which is representative in terms of terrain and wind resource in the wind power plant is selected, an anemometer tower is arranged within a range of twofold to fourfold wind turbine diameter (a twofold wind turbine diameter is recommended), a cup anemometer and a wind vane are mounted on the anemometer tower to measure wind velocity and wind direction signals; or a Lidar is used for measuring the wind velocity and wind direction signals.

a mean of measured data of 2 min is used for data analysis, the nacelle wind velocity is an independent variable (axis x), and a measured wind velocity is a dependent variable (axis y). A wind velocity range is divided into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, and data should include wind velocities which are comprised between 1 m/s lower than a cut-in wind velocity and 1.5 times of a wind velocity corresponding to rated power 85% of the wind turbine generator. When there are at least three data in each interval, it is determined that a data volume meets a requirement.

The NTF is defined as a function of a nacelle wind velocity (V_{nacelle}) in each interval which is used as a measured wind velocity (V). The NTF is effective only from a lowest wind velocity interval to a highest wind velocity interval, and NTF extrapolation is not allowed.

An NTF represented by an interval-based mathematical function is obtained by fitting, and the NTF should consider a sector free of influence of wake streams of other operating wind turbine generators and obstacles only.

After the NTF is obtained, a corrected wind velocity V_{free} is calculated according to the following formula:

$${V}_{free} = \frac{{V}_{m , i + 1} - {V}_{m , i}}{{V}_{nacelle , i + 1} - {V}_{nacelle , i}} \times ( {V}_{nacelle} - {V}_{nacelle , i} ) + {V}_{m , i} , \qquad ( 1 )$$

in the formula:

V_{nacelle,i} and V_{nacelle,i+1} being interval means (obtained through the NTF) of nacelle wind velocities in an interval i and an interval i+1,

V_{m,i} and V_{m,i+1} being interval means (obtained through the NTF) of wind velocities of the anemometer tower in the interval i and the interval i+1,

V_{nacelle} being a measured value of the nacelle anemometer and being used for estimating the free stream wind velocity, and

V_{free} being the free stream wind velocity estimated by adopting a measured nacelle wind velocity and a wind velocity of the anemometer tower and corrected in consideration of an air flow distortion caused by a terrain.

In the method, before measurement is carried out, site calibration is not required, but an application range of obtained NTF data is only limited to the wind power plant on which measurement is carried out.

(III) The Calculation of the Wind Turbine Generator Power Curve:

A measurement power curve of the evaluated wind turbine generator is calculated by virtue of the corrected nacelle wind velocity and output power of the wind turbine generator, it is determined whether a power curve guarantee value k of the evaluated wind turbine generator may reach a value guaranteed by a manufacturer. Data for calculation uses a mean of 10 min, and only data in the sector free of the influence of the wake streams of the other operating wind turbine generators and obstacles is considered.

All measured data should be standardized to a sea-level air density, and with reference to an ISO standard atmospheric density (1.225 kg/m3), output power of a fixed-pitch and fixed-velocity stall regulation wind turbine generator should be standardized according to the following formula:

$${P}_{n} = {P}_{10 min} \cdot \frac{{ρ}_{0}}{{ρ}_{10 min}} , \qquad ( 2 )$$

in the formula:

Pₙ being the standardized output power,

P_{10 min} being a measurement power mean of 10 min, and

ρ₀ being a standard air density.

The air density may be obtained from an air temperature and an air pressure according to the following formula:

$${ρ}_{10 min} = \frac{{B}_{10 min}}{{R}_{0} \cdot {T}_{10 min}} , \qquad ( 3 )$$

in the formula:

ρ_{10 min} being an air density mean of 10 min,

T_{10 min} being an absolute air temperature mean of 10 min,

B_{10 min} being an air pressure mean of 10 min, and

R₀ being a gas constant 287.05 J/(kg×K) of dry air.

Notes: the air temperature and air pressure means of 10 min are usually exported from the master control operation data of the wind turbine generator, and if they cannot be obtained from the master control operation data, air temperature and air pressure data measured at another position in the same wind power plant may also be used; and if there is no measured air pressure data, an air pressure value provided in a project engineering bidding document of the wind power plant can be adopted, or the air pressure data can be calculated from an altitude.

As for an active power controlled wind turbine generator, the wind velocity should be standardized according to the following formula:

$${V}_{n} = {{V}_{10 min} ( \frac{{ρ}_{10 min}}{{ρ}_{0}} )}^{1 / 3} , \qquad ( 4 )$$

in the formula:

Vₙ being the standardized wind velocity, and

V_{10 min} being a measured wind velocity mean of 10 min.

The measurement power curve is determined by applying an “interval method” to a standardized dataset, and namely, is obtained by calculating a standardized wind velocity mean and standardized output power mean of each wind velocity interval of 0.5 m/s intervals according to the following formulas:

$$\begin{matrix}{V}_{i} = \frac{1}{{N}_{i}} {\sum }_{j = 1}^{{N}_{i}} {V}_{n , i , j} & ( 5 ) \\ {P}_{i} = \frac{1}{{N}_{i}} {\sum }_{j = 1}^{{N}_{i}} {P}_{n , i , j} , & ( 6 )\end{matrix}$$

in the formulas:

Vᵢ being a standardized mean wind velocity of an interval i,

V_{n,i,j} being a standardized wind velocity of an array j of the interval i,

Pᵢ being standardized mean output power of the interval i,

P_{n,i,j} being standardized mean output power of the array j of the interval i, and

Nᵢ being the number of arrays in the interval i of 10 min

The AEP is estimated by applying the power curve to a frequency distribution of different reference wind velocities, the frequency distributions of the wind velocities may adopt wind resource data at hub height provided in the project engineering bidding document of the wind power plant, and a Rayleigh distribution completely the same as a Weibull distribution with a shape parameter of 2 may also be adopted as the frequency distribution of the reference wind velocities (as shown in formula 8). Measured AEP (AEP-measured value) is obtained by the measurement power curve; and guaranteed AEP (AEP-guarantee value) is obtained by a power curve guaranteed by a contract.

The AEP may be estimated according to the following formula:

$$AEP = {N}_{h} {\sum }_{i = 1}^{N} [ F ( {V}_{i} ) - F ( {V}_{i - 1} ) ] ( \frac{{P}_{i - 1} + {P}_{i}}{2} ) , \qquad ( 7 )$$

in the formula:

AEP being the Annual Energy Production,

Nₕ being the number of hours in a year, and being about 8,760 hours,

N being the number of the intervals,

Vᵢ being the standardized mean wind velocity of the interval i, and

Pᵢ being the standardized mean output power of the interval i.

Moreover:

$$F ( V ) = 1 - exp ( - \frac{π}{4} {( \frac{V}{{V}_{ave}} )}^{2} ) , \qquad ( 8 )$$

in the formula:

F(V) being a Rayleigh cumulative probability distribution function of the wind velocity,

Vₐᵥₑ being an annual mean wind velocity of a hub height, and

V being the wind velocity.

Summation initialization setting is performed: Vᵢ₋₁ is equal to Vᵢ−0.5 m/s, and Pᵢ₋₁ to be equal to 0.0 kW;

The wind resource data at the hub height, which is provided in the project engineering bidding document of the wind power plant, is adopted for the annual mean wind velocity at the hub height.

Power curve guarantee value k=(AEP-measured value/AEP-guarantee value)×100% (9)

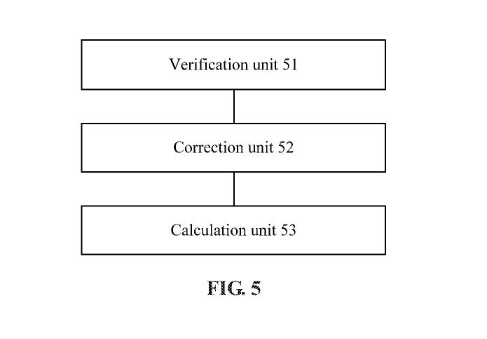

FIG. 5 is a structure diagram of a power performance evaluation device of wind turbine generator according to an embodiment of the disclosure. As shown in FIG. 5, the device includes:

a verification unit 51, configured to verify the master control operation data of the wind turbine generator;

a correction unit 52, configured to correct nacelle wind velocity data; and

a calculation unit 53, configured to calculate a power curve of the wind turbine generator and a power curve guarantee value, and obtain a power performance evaluation result of the wind turbine generator.

The verification unit 51 is further configured to execute the following process of:

acquiring master control operation data output by a master control system of the wind turbine generator as theoretical data, the master control operation data including a nacelle wind velocity and an output power signal;

verifying whether the master control operation data is the same as practical measurement data;

if the master control operation data is the same as practical measurement data, correcting the nacelle wind velocity data; and

if the master control operation data is not the same as practical measurement data, checking the input and output of the wind turbine generator controller signal, and controlling the master control system to correct the wind turbine generator controller signal.

The correction unit 52 is further configured to execute the following process of:

determining whether an authenticated NTF has been acquired;

if the authenticated NTF has been acquired, correcting the nacelle wind velocity data directly by virtue of the authenticated NTF;

if the authenticated NTF has not been acquired, selecting a typical wind turbine generator in the wind power plant;

arranging an anemometer tower within a range of twofold to fourfold wind turbine diameter of the typical wind turbine generator, and measuring wind velocity and wind direction signals on the anemometer tower;

calculating means of measured wind velocity and wind direction signal data within 2 min, the nacelle wind velocity being an independent variable and a measured wind velocity being a dependent variable, dividing a wind velocity range into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, data in the intervals including a wind velocities which are comprised between 1 m/s lower than a cut-in wind velocity and 1.5 times of a wind velocity corresponding to rated power 85% of the wind turbine generator, and when there are at least three data in each interval, obtaining an NTF represented by an interval-based mathematical function by fitting, the NTF being a function in which nacelle wind velocities in each interval are used as measured wind velocities; and calculating the free stream wind velocity.

The calculation unit 53 is further configured to execute the following process of:

calculating a measurement power curve and power curve guarantee value of the evaluated wind turbine generator according to the corrected nacelle wind velocity and output power of the wind turbine generator; and

determining whether the power curve guarantee value of the evaluated wind turbine generator reaches a value guaranteed by a manufacturer, and obtaining the power performance evaluation result of the wind turbine generator.

During a practical application, a function realized by each unit in the power performance evaluation device of the wind turbine generator may be realized by a Central Processing Unit (CPU), or Micro Processor Unit (MPU), or Digital Signal Processor (DSP), or Field Programmable Gate Array (FPGA) or the like located in a neighbor optimization device.

When being implemented in form of software function module and sold or used as an independent product, the wind turbine generator power performance evaluation device of the embodiment of the disclosure may also be stored in a computer-readable storage medium. Based on such an understanding, the technical solution of the embodiment of the disclosure (or parts making contributions to a conventional art) may be embodied in form of software product, and the computer software product is stored in a storage medium, including a plurality of instructions configured to enable a computer equipment (which may be a personal computer, a server, network equipment or the like) to execute all or part of the steps of the method in each embodiment of the disclosure. The abovementioned storage medium includes: various media capable of storing program codes, such as a U disk, a mobile hard disk, a Read Only Memory (ROM), a magnetic disk or an optical disk. Therefore, the embodiments of the disclosure are not limited to any specific combination of hardware and software.

Correspondingly, the embodiments of the disclosure further provide a storage medium, in which a computer program is stored, the computer program being configured to execute the evaluation method for evaluating power performance of a wind turbine generator of the embodiments of the disclosure.

The above embodiments are adopted not to limit but only to describe the technical solutions of the disclosure. Although the disclosure has been described with reference to the abovementioned embodiments in detail, those skilled in the art may still made modifications or equivalent replacements to the specific implementation modes of the disclosure, and any modifications or equivalent replacements made without departing from the spirit and scope of the disclosure fall within the scope of protection of the claims of the disclosure.

1. A power performance evaluation method for a wind turbine generator, adapted to evaluate power performance of the wind turbine generator in a wind power plant, the wind turbine generator being connected with a master control system of the wind turbine generator and a wind turbine generator controller to evaluate the power performance of the wind turbine generator, the method comprising:
verifying master control operation data of the wind turbine generator;
correcting a nacelle wind velocity data; and
calculating a wind turbine generator power curve and a power curve guarantee value, and obtaining a power performance evaluation result of the wind turbine generator.

2. The method according to claim 1, wherein verifying the master control operation data of the wind turbine generator comprises:
outputting, by the master control system, the master control operation data used as theoretical data, the master control operation data comprising a nacelle wind velocity and an output power signal;
verifying whether the master control operation data is the same as practical measurement data;
if the master control operation data is the same as practical measurement data, correcting the nacelle wind velocity data; and
if the master control operation data is not the same as practical measurement data, checking input and output of a signal of the wind turbine generator controller, and controlling the master control system to correct the signal of the wind turbine generator controller.

3. The method according to claim 1, wherein correcting the nacelle wind velocity data comprises:
determining whether an authenticated nacelle transfer function has been acquired;
if the authenticated nacelle transfer function has been acquired, correcting the nacelle wind velocity data directly by virtue of the authenticated nacelle transfer function;
if the authenticated nacelle transfer function has not been acquired, selecting a typical wind turbine generator in the wind power plant;
arranging an anemometer tower within a range of twofold to fourfold wind turbine diameter of the typical wind turbine generator, and measuring wind velocity and wind direction signals on the anemometer tower;
calculating a mean of measured wind velocity and wind direction signal data within 2 min, nacelle wind velocity being an independent variable and a measured wind velocity being a dependent variable, dividing a wind velocity range into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, data in the intervals comprising wind velocities which are comprised between 1 m/s lower than a cut-in wind velocity and 1.5 times of a wind velocity corresponding to rated power 85% of the wind turbine generator, and when there are at least three data in each interval, obtaining an nacelle transfer function represented by an interval-based mathematical function by fitting, the nacelle transfer function being a function in which nacelle wind velocities in each interval are used as measured wind velocities; and
calculating a free stream wind velocity.

4. The method according to claim 3, wherein measuring the wind velocity and wind direction signals on the anemometer tower comprises:
mounting a cup anemometer and a wind vane on the anemometer tower, and measuring, by the cup anemometer and the wind vane, the wind velocity and wind direction signals;
or mounting a Lidar on the anemometer tower, and measuring, by the Lidar, the wind velocity and wind direction signals.

5. The method according to claim 3, wherein calculating the free stream wind velocity comprises:
calculating the free stream wind velocity V_{free} which is estimated by the nacelle wind velocity and a wind velocity of the anemometer tower and corrected in consideration of an air flow distortion caused by a terrain according to the nacelle transfer function:
$${V}_{free} = \frac{{V}_{m , i + 1} - {V}_{m , i}}{{V}_{nacelle , i + 1} - {V}_{nacelle , i}} \times ( {V}_{nacelle} - {V}_{nacelle , i} ) + {V}_{m , i} ,$$
where V_{nacelle} is the nacelle wind velocity in each interval, Vₘ is the measured wind velocity, V_{nacelle,i} and V_{nacelle,i+1} are interval means of the nacelle wind velocities in an interval i and an interval i+1 respectively, and are obtained through the nacelle transfer function, V_{m,i} and V_{m,i+1} are interval means of wind velocities of the anemometer tower in the interval i and the interval i+1 respectively, and are obtained through the nacelle transfer function, and V_{nacelle} is a measured value of a nacelle anemometer, and is configured to estimate the free stream wind velocity.

6. The method according to claim 1, wherein calculating the wind turbine generator power curve and the power curve guarantee value and obtaining the power performance evaluation result of the wind turbine generator comprises:
calculating a measurement power curve and power curve guarantee value of the evaluated wind turbine generator according to the corrected nacelle wind velocity and output power of the wind turbine generator; and
determining whether the power curve guarantee value of the evaluated wind turbine generator reaches a value guaranteed by a manufacturer and obtaining the power performance evaluation result of the wind turbine generator.

7. The method according to claim 6, wherein calculating the measurement power curve and power curve guarantee value of the evaluated wind turbine generator according to the corrected nacelle wind velocity and output power of the wind turbine generator comprises:
standardizing all measured data to a sea-level air density, and standardizing output power of a fixed-pitch and fixed-velocity stall regulation wind turbine generator according to an International Standardization Organization standard atmospheric density:
$${P}_{n} = {P}_{10 min} \cdot \frac{{ρ}_{0}}{{ρ}_{10 min}} ,$$
where Pₙ is the standardized output power, P_{10 min} is a measured power mean of 10 min, ρ₀ is a standard air density, and ρ_{10 min} is an air density mean of 10 min,
wherein ρ_{10 min} is:
$${ρ}_{10 min} = \frac{{B}_{10 min}}{{R}_{0} \cdot {T}_{10 min}} ,$$
where T_{10 min} is an absolute air temperature mean of 10 min, B_{10 min} is an air pressure mean of 10 min, and R₀ is a gas constant 287.05 J/(kg×K) of dry air;
standardizing a wind velocity of an active power controlled wind turbine generator:
$${V}_{n} = {{V}_{10 min} ( \frac{{ρ}_{10 min}}{{ρ}_{0}} )}^{1 \text{/} 3} ,$$
where Vₙ is the standardized wind velocity, and V_{10 min} is a measured wind velocity mean of 10 min;
calculating a standardized mean wind velocity Vᵢ and mean output power Pᵢ of the interval i to be:
$${V}_{i} = \frac{1}{{N}_{i}} {Σ}_{j = 1}^{{N}_{i}} {V}_{n , i , j}$$
$${P}_{i} = \frac{1}{{N}_{i}} {Σ}_{j = 1}^{{N}_{i}} {P}_{n , i , j} ,$$
where V_{n,i,j} is a standardized wind velocity of an array j of the interval i, P_{n,i,j} is standardized mean output power of the array j of the interval i, and Nᵢ is the number of arrays in the interval i of 10 min;
obtaining measured Annual Energy Production (AEP) by the measurement power curve, obtaining guaranteed energy production by a power curve guaranteed by a contract, and estimating the annual energy production, AEP, according to the following formula:
$$AEP = {N}_{h} {Σ}_{i = 1}^{N} [ F ( {V}_{i} ) - F ( {V}_{i - 1} ) ] ( \frac{{P}_{i - 1} + {P}_{i}}{2} ) ,$$
where Nₕ is the number of hours in a year, and is about 8,760 hours, N is the number of the intervals, and F(V) is a Rayleigh cumulative probability distribution function of the wind velocity,
wherein F(V) is
$$F ( V ) = 1 - exp ( - \frac{π}{4} {( \frac{V}{{V}_{ave}} )}^{2} ) ,$$
where Vₐᵥₑ is an annual mean wind velocity at a hub height, and V is the wind velocity;
performing summation initialization setting:
setting Vᵢ₋₁ to be equal to Vᵢ−0.5 m/s, and setting Pᵢ₋₁ to be equal to 0.0 kW; and
adopting wind resource data at hub height, which is provided in a project engineering bidding document of the wind power plant, as the annual mean wind velocity of the hub height, and obtaining the power curve guarantee value k:
k=(AEP-measured value/AEP-guarantee value)×100%.

8. A power performance evaluation device of a wind turbine generator, comprising:
a verification unit, configured to verify a master control operation data of the wind turbine generator;
a correction unit, configured to correct nacelle wind velocity data; and
a calculation unit, configured to calculate a wind turbine generator power curve and a power curve guarantee value, and obtain a power performance evaluation result of the wind turbine generator.

9. The device according to claim 8, wherein the verification unit is further configured to execute the following process of:
acquiring the master control operation data output by a master control system of the wind turbine generator as theoretical data, the master control operation data comprising a nacelle wind velocity and an output power signal;
verifying whether the master control operation data is the same as practical measurement data;
if the master control operation data is the same as practical measurement data, correcting the nacelle wind velocity data; and
if the master control operation data is not the same as practical measurement data, checking input and output of a signal of a wind turbine generator controller, and controlling the master control system to correct the signal of the wind turbine generator controller.

10. The device according to claim 8, wherein the correction unit is further configured to execute the following process of:
determining whether an authenticated nacelle transfer function has been acquired;
if the authenticated nacelle transfer function has been acquired, correcting the nacelle wind velocity data directly by virtue of the authenticated nacelle transfer function;
if the authenticated nacelle transfer function has not been acquired, selecting a typical wind turbine generator in a wind power plant;
arranging an anemometer tower within a range of twofold to fourfold wind turbine diameter of the typical wind turbine generator, and measuring wind velocity and wind direction signals on the anemometer tower;
calculating a mean of measured wind velocity and wind direction signal data within 2 min, nacelle wind velocity being an independent variable and a measured wind velocity being a dependent variable, dividing a wind velocity range into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, data in the intervals comprising wind velocities which are comprised between 1 m/s lower than a cut-in wind velocity and 1.5 times of a wind velocity corresponding to rated power 85% of the wind turbine generator, and when there are at least three data in each interval, obtaining an nacelle transfer function represented by an interval-based mathematical function by fitting, the nacelle transfer function being a function in which nacelle wind velocities in each interval are used as measured wind velocities; and
calculating a free stream wind velocity.

11. The device according to claim 8, wherein the calculation unit is further configured to execute the following process of:
calculating a measurement power curve and power curve guarantee value of the evaluated wind turbine generator according to the corrected nacelle wind velocity and output power of the wind turbine generator; and
determining whether the power curve guarantee value of the evaluated wind turbine generator reaches a value guaranteed by a manufacturer, and obtaining the power performance evaluation result of the wind turbine generator.

12. A non-transitory storage medium, in which a computer-executable instruction is stored, the computer-executable instruction being configured to execute a power performance evaluation method for a wind turbine generator, the power performance evaluation method being adapted to evaluate power performance of the wind turbine generator in a wind power plant, the wind turbine generator being connected with a master control system of the wind turbine generator and a wind turbine generator controller to evaluate the power performance of the wind turbine generator, the method comprising:
verifying master control operation data of the wind turbine generator;
correcting a nacelle wind velocity data; and
calculating a wind turbine generator power curve and a power curve guarantee value, and obtaining a power performance evaluation result of the wind turbine generator.

13. The non-transitory storage medium according to claim 12, wherein verifying the master control operation data of the wind turbine generator comprises:
outputting, by the master control system, the master control operation data used as theoretical data, the master control operation data comprising a nacelle wind velocity and an output power signal;
verifying whether the master control operation data is the same as practical measurement data;
if the master control operation data is the same as practical measurement data, correcting the nacelle wind velocity data; and
if the master control operation data is not the same as practical measurement data, checking input and output of a signal of the wind turbine generator controller, and controlling the master control system to correct the signal of the wind turbine generator controller.

14. The non-transitory storage medium according to claim 12, wherein correcting the nacelle wind velocity data comprises:
determining whether an authenticated nacelle transfer function has been acquired;
if the authenticated nacelle transfer function has been acquired, correcting the nacelle wind velocity data directly by virtue of the authenticated nacelle transfer function;
if the authenticated nacelle transfer function has not been acquired, selecting a typical wind turbine generator in the wind power plant;
arranging an anemometer tower within a range of twofold to fourfold wind turbine diameter of the typical wind turbine generator, and measuring wind velocity and wind direction signals on the anemometer tower;
calculating a mean of measured wind velocity and wind direction signal data within 2 min, nacelle wind velocity being an independent variable and a measured wind velocity being a dependent variable, dividing a wind velocity range into continuous intervals according to the nacelle wind velocity, the continuous intervals are achieved as follows: wind velocities of integral multiple of 0.5 m/s are used as centers and two continuous intervals of a range of 0.25 m/s are demarcated on left and right sides of the centers, data in the intervals comprising wind velocities which are comprised between 1 m/s lower than a cut-in wind velocity and 1.5 times of a wind velocity corresponding to rated power 85% of the wind turbine generator, and when there are at least three data in each interval, obtaining an nacelle transfer function represented by an interval-based mathematical function by fitting, the nacelle transfer function being a function in which nacelle wind velocities in each interval are used as measured wind velocities; and
calculating a free stream wind velocity.

15. The non-transitory storage medium according to claim 14, wherein measuring the wind velocity and wind direction signals on the anemometer tower comprises:
mounting a cup anemometer and a wind vane on the anemometer tower, and measuring, by the cup anemometer and the wind vane, the wind velocity and wind direction signals;
or mounting a Lidar on the anemometer tower, and measuring, by the Lidar, the wind velocity and wind direction signals.

16. The non-transitory storage medium according to claim 14, wherein calculating the free stream wind velocity comprises:
calculating the free stream wind velocity V_{free} which is estimated by the nacelle wind velocity and a wind velocity of the anemometer tower and corrected in consideration of an air flow distortion caused by a terrain according to the nacelle transfer function:
$${V}_{free} = \frac{{V}_{m , i + 1} - {V}_{m , i}}{{V}_{nacelle , i + 1} - {V}_{nacelle , i}} \times ( {V}_{nacelle} - {V}_{nacelle , i} ) + {V}_{m , i} ,$$
where V_{nacelle} is the nacelle wind velocity in each interval, Vₘ is the measured wind velocity, V_{nacelle,i} and V_{nacelle,i+1} are interval means of the nacelle wind velocities in an interval i and an interval i+1 respectively, and are obtained through the nacelle transfer function, V_{m,i} and V_{m,i+1} are interval means of wind velocities of the anemometer tower in the interval i and the interval i+1 respectively, and are obtained through the nacelle transfer function, and V_{nacelle} is a measured value of a nacelle anemometer, and is configured to estimate the free stream wind velocity.

17. The non-transitory storage medium according to claim 12, wherein calculating the wind turbine generator power curve and the power curve guarantee value and obtaining the power performance evaluation result of the wind turbine generator comprises:
calculating a measurement power curve and power curve guarantee value of the evaluated wind turbine generator according to the corrected nacelle wind velocity and output power of the wind turbine generator; and
determining whether the power curve guarantee value of the evaluated wind turbine generator reaches a value guaranteed by a manufacturer and obtaining the power performance evaluation result of the wind turbine generator.

18. The non-transitory storage medium according to claim 17, wherein calculating the measurement power curve and power curve guarantee value of the evaluated wind turbine generator according to the corrected nacelle wind velocity and output power of the wind turbine generator comprises:
standardizing all measured data to a sea-level air density, and standardizing output power of a fixed-pitch and fixed-velocity stall regulation wind turbine generator according to an International Standardization Organization standard atmospheric density:
$${P}_{n} = {P}_{10 min} \cdot \frac{{ρ}_{0}}{{ρ}_{10 min}} ,$$
where Pₙ is the standardized output power, P_{10 min} is a measured power mean of 10 min, ρ₀ is a standard air density, and ρ_{10 min} is an air density mean of 10 min,
wherein ρ_{10 min} is:
$${ρ}_{10 min} = \frac{{B}_{10 min}}{{R}_{0} \cdot {T}_{10 min}} ,$$
where T_{10 min} is an absolute air temperature mean of 10 min, B_{10 min} is an air pressure mean of 10 min, and R₀ is a gas constant 287.05 J/(kg×K) of dry air;
standardizing a wind velocity of an active power controlled wind turbine generator:
$${V}_{n} = {{V}_{10 min} ( \frac{{ρ}_{10 min}}{{ρ}_{0}} )}^{1 \text{/} 3} ,$$
where Vₙ is the standardized wind velocity, and V_{10 min} is a measured wind velocity mean of 10 min;
calculating a standardized mean wind velocity Vᵢ and mean output power Pᵢ of the interval i to be:
$${V}_{i} = \frac{1}{{N}_{i}} {Σ}_{j = 1}^{{N}_{i}} {V}_{n , i , j}$$
$${P}_{i} = \frac{1}{{N}_{i}} {Σ}_{j = 1}^{{N}_{i}} {P}_{n , i , j} ,$$
where V_{n,i,j} is a standardized wind velocity of an array j of the interval i, P_{n,i,j} is standardized mean output power of the array j of the interval i, and Nᵢ is the number of arrays in the interval i of 10 min;
obtaining measured Annual Energy Production (AEP) by the measurement power curve, obtaining guaranteed energy production by a power curve guaranteed by a contract, and estimating the annual energy production, AEP, according to the following formula:
$$AEP = {N}_{h} {Σ}_{i = 1}^{N} [ F ( {V}_{i} ) - F ( {V}_{i - 1} ) ] ( \frac{{P}_{i - 1} + {P}_{i}}{2} ) ,$$
where Nₕ is the number of hours in a year, and is about 8,760 hours, N is the number of the intervals, and F(V) is a Rayleigh cumulative probability distribution function of the wind velocity,
wherein F(V) is:
$$F ( V ) = 1 - exp ( - \frac{π}{4} {( \frac{V}{{V}_{ave}} )}^{2} ) ,$$
where Vₐᵥₑ is an annual mean wind velocity at a hub height, and V is the wind velocity;
performing summation initialization setting:
setting Vᵢ₋₁ to be equal to Vᵢ−0.5 m/s, and setting Pᵢ₋₁ to be equal to 0.0 kW; and
adopting wind resource data at hub height, which is provided in a project engineering bidding document of the wind power plant, as the annual mean wind velocity of the hub height, and obtaining the power curve guarantee value k:
k=(AEP-measured value/AEP-guarantee value)×100%.

19. The method according to claim 1, wherein correcting the nacelle wind velocity data comprises:
arranging an anemometer tower within a range of twofold to fourfold wind turbine diameter of a typical wind turbine generator, and measuring wind velocity on the anemometer tower and wind direction signals on the anemometer tower; and
calculating a mean of measured wind velocity and wind direction signal data generated from the wind direction signals.

20. The method according to claim 19, wherein measuring the wind velocity and wind direction signals on the anemometer tower comprises:
mounting a cup anemometer and a wind vane on the anemometer tower, and measuring, by the cup anemometer and the wind vane, the wind velocity and wind direction signals;
or mounting a Lidar on the anemometer tower, and measuring, by the Lidar, the wind velocity and wind direction signals.
